(19) United States
(12) Patent Application Publication
(10) Pub. No.: US 2015/0370922 A1
(43) Pub. Date: Dec. 24, 2015

(54) SUBSCRIPTION NOTIFICATION AND REPLICATION

(71) Applicant: MICROSOFT CORPORATION, Redmond, WA (US)

(72) Inventor: Yoav HELFMAN, Redmond, WA (US)

(21) Appl. No.: 14/313,635

(22) Filed: Jun. 24, 2014

(51) Int. Cl. G06F 17/30; G06Q 20/02; G06Q 20/14

(52) U.S. Cl. CPC G06F 17/30997; G06F 17/30117; G06Q 20/14; G06Q 20/02

(57) ABSTRACT

Methods, systems, and computer storage media for routing approval and costing information for tenant plan subscriptions. Tenant plans include resource provider services in a cloud computing infrastructure and the amount of the one or more resource provider services to be dedicated to the tenant plan subscription. Resource provider services are services in a cloud-computing infrastructure. Approval of tenant plan subscriptions and requested information can be routed from an administrator application to an external billing system by a subscription and metadata service. Approval and or costing information is then routed from the billing system to the administrator application by the subscription and metadata service. The subscription and metadata service also logs tenant plan subscriptions and the addition or deletion of resource provider services to each tenant plan subscription such that multiple tenant plan subscriptions and changes may be recreated at a later time if a billing system fails or loses data.

### BACKGROUND

Large-scale networked systems in a cloud computing environment are commonplace systems employed in a variety of settings for running service applications and maintaining data for business and operational functions. For instance, a data center within an enterprise networked system may support operation of a variety of differing resources (e.g., virtual machines, web applications, email services, search engine services, etc.) in a cloud computing environment and include multiple billing systems.

Furthermore, where there are multiple billing systems used to bill for use of resources a cloud computing environment providing approval and information to tenants cannot be solved using conventional techniques. Conventional techniques are not extensible to a cloud environment that is rapidly evolving. The distributed nature and unique structure of the cloud computing environments makes managing multiple billing systems and tenants difficult.

### SUMMARY

This Summary is provided to introduce concepts in a simplified form that are further described below in the Detailed Description. This Summary is not intended to identify key features or essential features of the claimed subject matter, nor is it intended to be used as an aid in determining the scope of the claimed subject matter.

Methods, systems, and computer storage media for routing approval and costing information for tenant plan subscriptions. Tenant plans include one or more resource provider services in a cloud computing infrastructure and the amount of the one or more resource provider services to be dedicated to the tenant plan subscription. Resource provider services may include virtual machines, websites, text messages and other services in a cloud-computing infrastructure. Approval of tenant plan subscriptions and requested information can be routed from an administrator application to an external billing system by a subscription and metadata service. Approval and or costing information is then routed from the billing system to the administrator application by the subscription and metadata service. The subscription and metadata service also logs tenant plan subscriptions and the addition or deletion of resource provider services to each tenant plan subscription such that multiple tenant plan subscriptions and changes may be recreated at a later time if a billing system fails or loses data.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates substantially similar or identical items.

FIG. 1 is a block diagram of an exemplary computing environment suitable for use in implementing embodiments of the present invention;

FIG. 2 is a block diagram illustrating an architecture of an exemplary cloud-computing infrastructure, suitable for use in implementing embodiments of the present invention;

FIG. 3 is a block diagram illustrating the subscription and metadata service, suitable for use in implementing embodiments of the present invention, that is configured to communicate with external billing systems and administrator applications;

FIG. 4 is block diagram of an exemplary data store in accordance with embodiments of the present invention;

FIG. 5 is a flow diagram of a method for routing subscription plan approval in a cloud computing infrastructure, in accordance with a method of the present invention;

FIG. 6 is a flow diagram of a method for recreating tenant plan subscriptions and changes in accordance with embodiments of the present invention; and

FIG. 7 is a flow diagram for routing costing requests in a cloud computing infrastructure in accordance with embodiments of the present invention.

### DETAILED DESCRIPTION

### Overview of Embodiments of the Invention

Embodiments of the present invention relate to methods, systems, and computer-storage media having computer-executable instructions embodied thereon that, when executed, perform methods in accordance with embodiments hereof, for management of resource quotas in a cloud-computing infrastructure.

Multiple and varied implementations and embodiments are described below. Having briefly described an overview of embodiments of the present invention, the following section describes an operating environment suitable for implementing embodiments of the present invention. The following sections describe illustrative aspects of the techniques for carrying out embodiments of the present invention.

### Exemplary Operating Environment

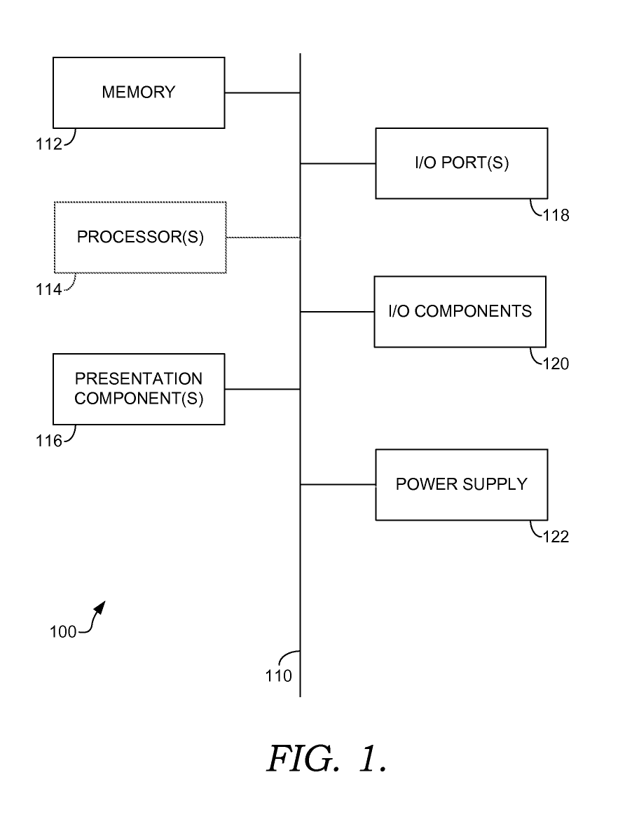

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The invention may be practiced in a variety of system configurations, including hand-held devices, consumer electronics, general-purpose computers, specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device”.

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media.

Computer storage media includes volatile and non-volatile, removable and non-removable media implemented in any method or technology for storage of information such as computer readable instructions, data structures, program modules, or other data. Computer storage media include, but are not limited to, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media typically embody computer-readable instructions, data structures, program modules, or other data in a modulated data signal, such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media; however, as defined herein, computer storage media does not include communication media.

Memory 112 includes computer-storage media in the form of volatile and/or nonvolatile memory. The memory may be removable, nonremovable, or a combination thereof. Exemplary hardware devices include solid-state memory, hard drives, optical-disk drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

Ports 118 allow computing device 100 to be logically coupled to other devices including I/O components 120, some of which may be built in. Illustrative components include a microphone, joystick, game pad, satellite dish, scanner, printer, wireless device, etc.

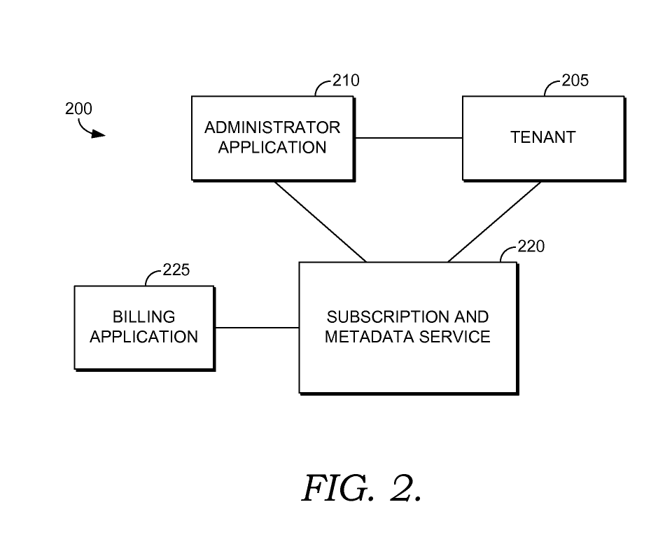

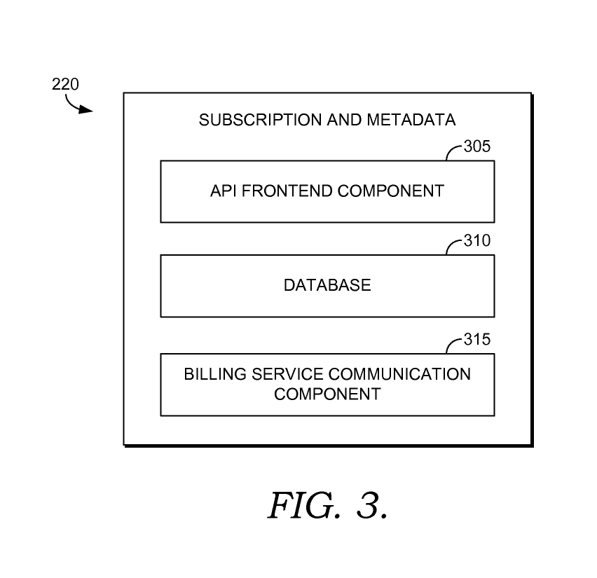

Turning now to FIG. 2 and FIG. 3, a block diagram illustrating architecture 200 of an exemplary cloud-computing infrastructure, suitable for use in implementing embodiments of the present invention, is shown. The cloud-computing infrastructure 200 includes subscription notification and metadata service 220 that is configured store user subscription information and while communicating with administrator application 210, tenants 205 and billing system 225 in a cloud-computing infrastructure. In an exemplary embodiment, the subscription and metadata service 220 is provided for performing a method for storing user subscription information and communicating with administrator application 210, tenants 205 and billing systems 225. The detailed components of subscription notification and metadata service 220 are described in FIG. 3.

Further, it will be understood and appreciated that the architecture 200 of the cloud-computing infrastructure shown in FIG. 2 is merely an example of one suitable computing system environment and is not intended to suggest any limitation as to the scope of use or functionality of embodiments of the present invention. For instance, the cloud-computing infrastructure may be a hybrid cloud environment, public cloud, a private cloud or dedicated cloud. Neither should the cloud-computing infrastructure be interpreted as having any dependency or requirement related to any single component or combination of components illustrated therein. Further, although the various blocks of FIG. 2 are shown with lines for the sake of clarity, in reality, delineating various components is not so clear, and metaphorically, the lines would more accurately be grey and fuzzy. In addition, any number of nodes, virtual machines, data centers, role instances, or combinations thereof may be employed to achieve the desired functionality within the scope of embodiments of the present invention.

The architecture 200 of the cloud-computing infrastructure may include one or more enterprise data centers (not shown) configured to host and/or support operation of resource provider services. It will be appreciated that while resource provider services are hosted by one or more data centers. It will be appreciated that resource provider services may be hosted at a data center different from the subscription notification and metadata system. Resource provider services could include virtual machines, website, text messages, data storage and servers. Servers and data storage are usable to execute computer operations. For examples, servers are used to execute applications of administrator, such as private cloud applications. In one embodiment, an administrator configures the technology for an entity, such as a business enterprise.

As used herein, the phrase “virtual machine” is not meant to be limiting, and may refer to any software, application, operating system, or program that is executed by a processing unit. Further, the virtual machines may include processing capacity, storage locations, and other assets. It will be understood and appreciated that the resource provider services are merely an example of suitable parts to support the cloud computing environment and are not intended to suggest any limitation as to the scope of use or functionality of embodiments of the present invention.

A data center is also configured to host and/or support service applications. The phrase “service application,” as used herein, broadly refers to any software, or portions of software, that runs on top of, or accesses storage locations within, the data center. An exemplary service application that could be hosted is subscription notification and metadata service 220.

An on-premises private cloud-computing environment is a set of resource provider services such as hardware, networking, storage, services, applications, and interfaces owned and operated by an entity, such as an enterprise, for the use of its sub-entities, partners, employees and customers. An on-premises private cloud is controlled by an entity and is not available for public use. An on-premises private cloud may include a data center including resource provider services 201-203. A private cloud typically is located behind a firewall and not available for public use. In some embodiments, a private cloud can be created and managed by a third party for the use of the entity. A public cloud is a set of resource provider services such as hardware, networking, storage, services, applications, and interfaces available for public use. An example of a public cloud is a data center that is available to the public via the Internet.

Embodiments of the present invention may also be utilized with a combination of a private cloud combined with the use of public cloud services where one or several touch points exist between the environments. The goal is to combine services and data from a variety of cloud models to create a unified, automated, and well-managed computing environment. For example, in a hybrid environment can use an on-premises data center of the private cloud and augment with resource provider services from the public cloud and vice versa. Embodiments of the present invention abstract the physical data center of a private enterprise or cloud such that both the private and public cloud can appear to work on the same network. A consistent platform is provided across private and public clouds such that administrators using administrator application 210 can provide and manage the resource provider services (private and public) for their tenants 205 (customers, employees, divisions and partners of the entity).

Administrators demand flexibility in a cloud computing environment to define plans, billing, services, cost, amounts quotas, and types (e.g., virtual machines vs. hardware). Administrators can utilize embodiments of the present invention to create a cloud computing network to offer and manage plans and services to tenants 205 (or customers). A plan is a package comprising a list of offered resource provider services and quotas for the resource provider services. A service quota is a set of quotas for a particular resource provider service. A quota is the share or proportional part of a total resource provider service that is allocated for a particular tenant plan subscription. The service quota for a subscription can be determined by a plan or add-on chosen by the tenant 205.

Once configured by the administrator, a plan can be offered to tenants 205 with pricing information. The pricing information may be obtained from the billing system 225 via the subscription notification and metadata service 220. A user or tenant 205 may be an employee, customer, partner, division or sub-entity of entity. For example, an administrator may build a basic cloud environment hosting plan that includes two types of resource provider services, including three virtual machines and one website that can be purchased by a tenant 205. Furthermore an administrator may build a premium plan hosting multiple resource provider services including use of six virtual machines, three websites, text messages and one e-mail address.

A tenant 205 may choose plans, add resource provider services, and delete subscriptions as needed. Furthermore, tenants can view pricing information for plans, add-ons and deletions based on information provided by the billing system 225. Tenants 205 can build and manage resource provider services locally in the private cloud or migrate to resource provider services on the public cloud through a single portal without require any change in coding.

Once a tenant 205 obtains a plan from an administrator application 210, the tenant 205 and the plan are registered with the subscription notification and metadata service 220. Entities, such as enterprises, typically track or charge divisions, partners or sub-entities based on usage of the entity's data center. Oftentimes this can be done as a charge back model or purchase model. Furthermore, customers of the entity may purchase usage of the entity's data center.

Once a plan is chosen by a tenant 205 the tenant plan subscription information is communicated to the subscription notification and metadata service 220. The subscription notification and metadata service 220 stores a subscription identifier for the tenant subscription plan. The subscription identifier for the tenant subscription plan is stored by the subscription notification and metadata 220 and communicated to the billing system 225. The subscription notification and metadata service 220, billing system 225 and tenants 205 can communicate with one another using a session referencing the tenant plan subscription.

After purchase and establishment of the tenant subscription, the administrator may offer additional resource provider services or larger service quotas (add-ons) to the tenant. The tenant may be offered additional resource provider services or additional service quotas (add-ons) for resource provider services.

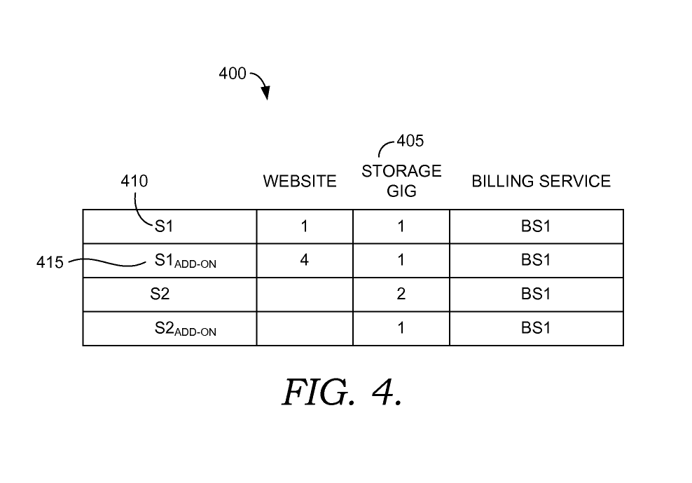

For example, with reference to FIG. 4, a data store 400 for subscription notification and metadata service 220 is shown. Data store 400 includes subscription identifiers for tenant plan subscriptions along with the service quotas for the resource provider services that are part of the tenant plan subscription. For example, subscription identifier S1 is for a tenant subscription plan that includes websites and storage. Any changes and/or add-ons to an individual tenant subscription plan are added to the same subscription number 410. The subscription notification and metadata service 220 stores the tenant plan subscriptions, updates (with add-ons) and deletions (CRUD) as shown in exemplary FIG. 4. For example, as can be seen in FIG. 4 subscription S1, has received changes and thus the subscription notification and metadata service 220 has updated the subscription quota and added four (4) additional websites to the original tenant plan subscription of one (1) website for a total of five (5) websites.

Furthermore, the subscription notification and metadata service 220 creates an audit trail of tenant plan subscriptions and add-ons such that the internal state of tenants, tenant plan subscriptions and add-ons may be recreated in an empty billing system for billing system 225 or another entity. The subscription notification and metadata service 220 provides a tracking system such that a historical trail can be built outside of the billing system 225 if the billing system 225 fails or loses tenant plan subscription information. In yet another embodiment, subscription and metadata service 220 can provide a full history of all metadata events over time and to be able to reconstruct a correct metadata snapshot at any time.

Embodiments of the present invention provide a single, consistent and cohesive application programing interface to communicate across administrators, tenants and multiple billing systems 225. Embodiments of the present invention can be integrated with third party billing systems and services 225. The subscription notification and metadata service 220 provides an interface to external billing systems 225, which will be notified of events such as tenant plan subscriptions, add-ons and deletions.

Referring to FIG. 3, the subscription and metadata service 220 may comprise a single software component or may be partitioned into a plurality of distinct software components that interact with each other in the cloud computing infrastructure. As illustrated in FIG. 3, the subscription and metadata service 220 is distributed into various software components. The subscription and metadata service 220 includes an API frontend component 305, subscription notification and metadata service database 310, and billing system communication component 315.

The API frontend component 305 exposes a set of unified subscription and API to either administrator application 210 or tenants 205 via a tenant portal. The API frontend component 305 is stateless and can be replicated. API frontend component 305 allows administrators 210 to incrementally add new features to existing plans (add-ons), which in turn, will allow existing tenants 205 to access new resource provider services. The plan and add-ons are communicated by the subscription and metadata event messaging layer.

The subscription and metadata database 310 stores information about, administrators 210, tenants 205, billing systems 225, commands and states. Subscription and metadata database database 310 stores subscription identifiers, tenant plan subscription information and add-ons.

The billing system communication component 315 provides contracts to be implemented by the billing system 225 such that the billing system 225 can communicate with the subscription and metadata service 220. Billing system communication component 315 is responsible for communicating tenant subscription plan approval and costing information from the billing system 225 to administrator application 210 (via the internal API interface). Using information provided by API frontend component 305 and billing system communication component 320, the billing system 225 and administrator application 210 can communicate with subscription and metadata service 220 in a unified fashion. Each billing system 225 is registered with the subscription and metadata service 220 one time and then can receive and implement the internal API contracts so that billing system 220 and administrator application 210 can communicate.

The billing system 215 may be an internal or external system to the data center. It also is integrated with the subscription and metadata service 220 via a one-time registration process utilizing the billing system communication module 320 and will be notified of any quota changes. The subscription and metadata service 220 treats this notification as first class and will not commit to further changes in tenant plan subscription unless it receives an acknowledgement from the billing system 225.

### Process Flows

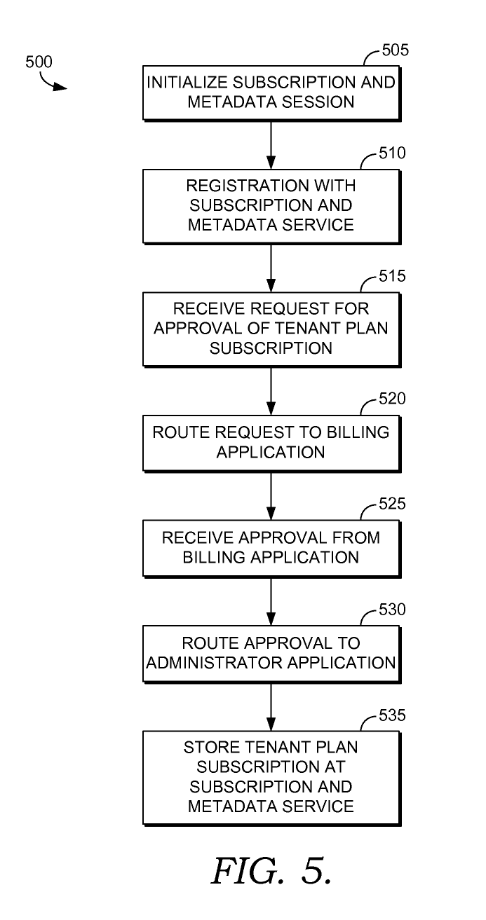

Exemplary methods for resource provider service quota management are described with reference to FIGS. 5-7. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Turning to FIG. 5, a flow diagram showing an overall method 500 for storing and routing tenant subscription plan approval is shown, in accordance with an embodiment of the present invention. It should be noted that, although the terms “step” and/or “block” may be used herein to connote different elements of methods employed, the terms should not be interpreted as implying any particular order among or between various steps herein disclosed unless and except when the order of individual steps is explicitly described.

Initially, the method 500 receives messages from an administrator application and billing system for initialization of a subscription and metadata management session at block 505. The administrator application and billing system register with the subscription and metadata service and at block 510 connect with the subscription and metadata service in order to start a subscription and metadata messaging session. The subscription and metadata service receives from the administrator application notification of one or more tenant plan subscriptions for approval at block 515. A plan comprises access to one or more resource provider services in a cloud computing infrastructure and specifies the amount of the one or more resource provider services to be dedicated to the tenant plan subscription. At block 520, the subscription and metadata service routes the approval request to billing system via the subscription and metadata messaging session.

After the billing system has reviewed the request, at block 525, the billing system returns to the subscription and metadata service approval (or disapproval) of the tenant plan subscription request. The billing system may approve based on a variety of reasons, including the availability of funds of the tenant or the types of plans allowed for the tenant based on contractual provisions. If the billing system returns approval, the approval is routed by the subscription and metadata service to the administrator application at block 530 and the subscription and metadata service stores the approved tenant plan subscription at block 535. In one embodiment, the approval (or disapproval) of the tenant plan subscription is treated as first class and a tenant plan subscription cannot be established without prior approval of the billing system. In addition, the billing system can be notified that a tenant plan subscription has been created and the billing system stores the tenant plan subscription and related information.

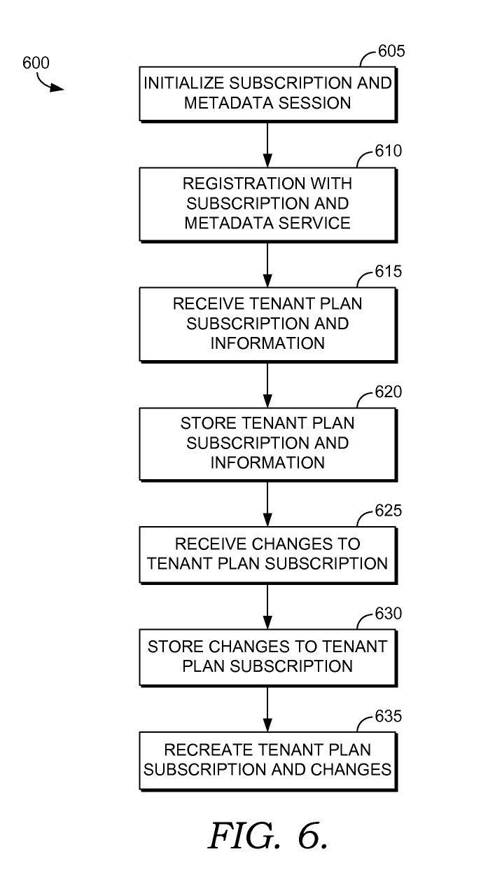

Referring next to FIG. 6, a flow diagram showing an overall method 600 for recreating tenant subscription plans and changes is shown, in accordance with an embodiment of the present invention. It should be noted that, although the terms “step” and/or “block” may be used herein to connote different elements of methods employed, the terms should not be interpreted as implying any particular order among or between various steps herein disclosed unless and except when the order of individual steps is explicitly described.

Initially, the method 600 receives messages from an administrator application and billing system for initialization of a subscription and metadata management session at block 605. The administrator application and billing system register with the subscription and metadata service and at block 610 connect with the subscription and metadata service in order to start a subscription and metadata messaging session. The subscription and metadata service receives from the administrator application notification of one or more tenant plan subscriptions and information related to that plan at block 615. A plan comprises access to one or more resource provider services in a cloud computing infrastructure and specifies the amount of the one or more resource provider services to be dedicated to the tenant plan subscription. At block 620, the subscription and metadata service stores the tenant plan subscription and related information in its database.

At block 625, changes to the tenant plan subscriptions, such as add-on resource provider services or deletion of a tenant plan subscription, are received by the subscription and metadata service. These changes are stored for the tenant plan subscription by the subscription and metadata service. At block 635, the tenant plan subscriptions, and indeed plan subscriptions for multiple tenants, may be recreated by the subscription and metadata service into an empty billing system or other application. It will be appreciated that method 600 may be performed for many different plan subscriptions for multiple tenants and changes and ultimately, an entire billing system may be recreated based on the information stored by the subscription and metadata service for redundancy purposes in the event of a failure or loss of data by the original billing system or administrator application.

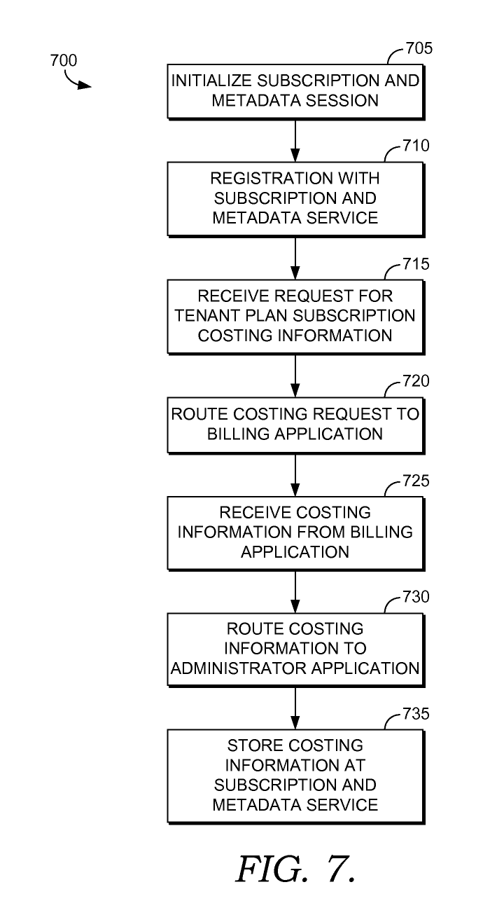

Referring next to FIG. 7, a flow diagram showing an overall method 700 for storing and routing tenant subscription plan costing requests is shown, in accordance with an embodiment of the present invention. It should be noted that, although the terms “step” and/or “block” may be used herein to connote different elements of methods employed, the terms should not be interpreted as implying any particular order among or between various steps herein disclosed unless and except when the order of individual steps is explicitly described.

Initially, the method 700 receives messages from an administrator application and billing system for initialization of a subscription and metadata management session at block 705. The administrator application and billing system register with the subscription and metadata service and at block 710 connect with the subscription and metadata service in order to start a subscription and metadata messaging session. The subscription and metadata service receives from the administrator application notification of one or more requests for costing information for one or more tenant plan subscriptions for approval at block 715. The costing request may be for an entirely new tenant plan subscription or changes to an existing tenant plan subscription such as adding additional cloud computing resources or removing certain cloud computing resources. The change may also be for change the proportion of resource services to be allocated to an existing tenant plan subscription. At block 720, the subscription and metadata service routes the costing request to billing system via the subscription and metadata messaging session.

After the billing system has reviewed the request, at block 725, the billing system returns to the subscription and metadata costing information requested for the tenant. The billing system may determine the costing information in any variety of ways, particularly based on contractual provisions with the tenant that may be known by the billing system. At block 730, the costing information is routed to the administrator application by the subscription and metadata service which may be provided to the tenant by the administrator. The subscription and metadata service stores the costing information and the request at block 735 such that it may be leveraged to recreate the tenant plan subscription at a later time and changes can be made to this information if requested.

Any of the acts of any of the methods described herein may be implemented at least partially by a processor or other electronic device based on instructions stored on one or more computer-readable media.

Although the invention has been described in language specific to structural features and/or methodological acts, it is to be understood that the invention is not necessarily limited to the specific features or acts described. Rather, the specific features and acts are disclosed as exemplary forms of implementing the invention. That is, embodiments of the present invention have been described in relation to particular embodiments, which are intended in all respects to be illustrative rather than restrictive. Alternative embodiments will become apparent to those of ordinary skill in the art to which embodiments of the present invention pertain without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

1. One or more computer storage media having computer-executable instructions embodied thereon that, when executed, perform a method for managing subscriptions and billing information within a cloud-computing infrastructure, the method comprising:
receiving messages from one or more administrator applications and one or more billing systems for a subscription and metadata session between an administrator application and one or more billing systems, the subscription and metadata session automatically pairs the administrator application, the one or more billing systems and a subscription and metadata service based on a subscription and metadata messaging layer that facilitates communication between the administrator application, the one or more billing systems and the subscription and metadata service;
connecting the administrator application, the one or more billing systems and the subscription and metadata service to subscription and metadata messaging layer for a subscription and metadata messaging session;
receiving at the subscription and metadata messaging service, from the administrator application, notification of a tenant subscribing to a plan created by a hosting administrator, the plan comprising access to one or more resource provider services in a cloud computing infrastructure and specifying the proportion of the one or more resource provider services to be dedicated to the tenant plan subscription;
storing at the subscription and metadata messaging service, a subscription identifier for the tenant plan subscription and proportion of the resource provider services to be dedicated to the tenant plan subscription;
routing via the subscription and metadata messaging layer a first message, including the subscription identifier for the tenant plan subscription and proportion of the resource provider services to be dedicated to the tenant plan subscription, to the one or more billing systems;
receiving at the metadata and subscription service, from the one or more billing systems, notification that the tenant has the funds available for the tenant subscription; and
routing via the metadata and subscription service, a message notifying the administrator application of approval of the tenant subscription based on available funds.

2. The media of claim 1, further comprising:
receiving at the subscription and metadata messaging service, from the administrator application, notification of a tenant requesting changes to an already existing tenant subscription plan, the changes comprising adding one or more service quotas for one or more resource provider services in a cloud computing environment, the additional one or more service quotas specifying the proportion of the one or more resource provider services to be dedicated to the existing tenant plan subscription;
routing via the subscription and metadata messaging layer a first message, including identifying the existing tenant plan subscription and requested changes to the existing tenant plan subscription;
receiving at the metadata and subscription service, from the one or more billing systems, notification that the tenant has the funds available for the requested changes to the existing tenant plan subscription;
storing at the subscription and metadata messaging service, the requested changes to the existing tenant plan subscription; and
routing via the metadata and subscription service, a message notifying the administrator application of approval of the requested changes to the existing tenant plan subscription based on available funds.

3. The media of claim 1, further comprising:
receiving at the subscription and metadata messaging service, from the administrator application, notification of a tenant requesting changes to an already existing tenant subscription plan, the changes comprising deleting the existing tenant subscription plan in a cloud computing environment;
routing via the subscription and metadata messaging layer to the one or more billing system a first message notifying of deletion of the existing tenant plan subscription; and
storing at the subscription and metadata messaging service, the requested deletion of the existing tenant plan subscription.

4. The media of claim 1, wherein there are multiple third-party billing systems.

5. The media of claim 4, wherein there are multiple administrator applications, tenants and tenant plan subscriptions.

6. The media of claim 1, wherein the resource provider services in the cloud computing infrastructure comprise one or more virtual machines, data storage, websites and text messages.

7. The media of claim 1, wherein cloud computing infrastructure is one of a private cloud computing infrastructure, a public cloud computing infrastructure and a hybrid private and public cloud computing infrastructure.

8. The media of claim 1, further comprising, routing via the metadata and subscription service, a message notifying the tenant of approval of requested tenant plan subscription.

9. One or more computer storage media having computer-executable instructions embodied thereon that, when executed, perform a method for managing subscriptions and billing information within a cloud-computing infrastructure, the method comprising:
receiving messages from an administrator application and one or more billing systems for a subscription and metadata session between an administrator application and one or more billing systems, the subscription and metadata session automatically pairs the administrator application, the one or more billing systems and a subscription and metadata service based on a subscription and metadata messaging layer that facilitates communication between the administrator application, the one or more billing systems and the subscription and metadata service;
connecting the administrator application, the one or more billing systems and the subscription and metadata service to subscription and metadata messaging layer for a subscription and metadata messaging session;
receiving at the subscription and metadata messaging service, from the administrator application, notification of a tenant subscribing to a plan created by a hosting administrator, the plan comprising access to one or more resource provider services in a cloud computing infrastructure and specifying the proportion of the one or more resource provider services to be dedicated to the tenant plan subscription;
storing at the subscription and metadata messaging service, a subscription identifier for the tenant plan subscription and proportion of the resource provider services to be dedicated to the tenant plan subscription;
receiving at the subscription and metadata messaging service, from the administrator application, notification of a tenant requesting changes to an already existing tenant subscription plan, the changes comprising adding one or more service quotas for one or more resource provider services in a cloud computing environment, the additional one or more service quotas specifying the proportion of the one or more resource provider services to be dedicated to the existing tenant plan subscription;
storing at the subscription and metadata messaging service, the requested changes to the existing tenant plan subscription;
recreating, based on the information stored at the subscription and metadata messaging service, the tenant plan subscription and changes to the tenant plan subscription.

10. The media of claim 9, wherein there are multiple administrator applications, billing systems, tenants and tenant plan subscriptions.

11. The media of claim 10, further comprising:
storing subscription identifiers for the multiple tenant plan subscriptions.

12. The media of claim 11, further comprising:
recreating for the one or more billing systems the multiple tenant plan subscriptions and changes to the tenant plan subscriptions.

13. The media of claim 9, wherein the tenant plan subscription is recreated in an empty billing system.

14. The media of claim 9, wherein cloud computing infrastructure is one of a private cloud computing infrastructure, a public cloud computing infrastructure and a hybrid private and public cloud computing infrastructure.

15. One or more computer storage media having computer-executable instructions embodied thereon that, when executed, perform a method for managing subscriptions and billing information within a cloud-computing infrastructure, the method comprising:
receiving messages from an administrator application and one or more billing systems for a subscription and metadata session between an administrator application and one or more billing systems, the subscription and metadata session automatically pairs the administrator application, the one or more billing systems and a subscription and metadata service based on a subscription and metadata messaging layer that facilitates communication between the administrator application, the one or more billing systems and the subscription and metadata service;
connecting the administrator application, the one or more billing systems and the subscription and metadata service to subscription and metadata messaging layer for a subscription and metadata messaging session;
receiving at the subscription and metadata messaging service, from the administrator application, one or more requests of a tenant for costing information for a subscription plan, wherein a subscription plan comprises access to one or more resource provider services in a cloud computing infrastructure and specifies the proportion of the one or more resource provider services to be dedicated to the plan subscription;
routing via the subscription and metadata messaging layer a first message, including the one or more requests of a tenant for costing information;
receiving at the metadata and subscription service, from the one or more billing systems, the requested costing information; and
routing via the metadata and subscription service, a message notifying the administrator application of the requested costing information.

16. The media of claim 15, further comprising:
receiving at the subscription and metadata messaging service, from the administrator application, notification of a tenant requesting costing information for changes to an already existing tenant subscription plan, the changes comprising adding one or more service quotas for one or more resource provider services in a cloud computing environment, the additional one or more service quotas specifying the proportion of the one or more resource provider services to be dedicated to the existing tenant plan subscription;
routing via the subscription and metadata messaging layer a first message, including identifying the existing tenant plan subscription and requested costing information for changes to the existing tenant plan subscription;
receiving at the metadata and subscription service, from the one or more billing systems, notification of the request costing information for changes to the existing tenant plan subscription;
storing at the subscription and metadata messaging service, the costing information for the existing tenant plan subscription; and
routing via the metadata and subscription service, a message notifying the administrator application of the costing information for the requested changes to the existing tenant plan subscription.

17. The media of claim 15, wherein there are multiple third-party billing systems.

18. The media of claim 17, wherein there are multiple administrator applications, tenants and tenant plan subscriptions.

19. The media of claim 15, wherein the resource provider services in the cloud computing infrastructure comprise one or more virtual machines, data storage, websites and text messages.

20. The media of claim 15, wherein cloud computing infrastructure is one of a private cloud computing infrastructure, a public cloud computing infrastructure and a hybrid private and public cloud computing infrastructure.
